(19) United States
(12) Patent Application Publication
(10) Pub. No.: US 2008/0190823 A1
(43) Pub. Date: Aug. 14, 2008

(54) Mechanical Device for the Concentration of Minerals

(76) Inventor: Pol Huart, Mons (BE)

Correspondence Address: Genimin, Avenue du General de Gaulle, 40-01, B7000, Mons, omitted

(21) Appl. No.: 11/547,523

(22) PCT Filed: Apr. 4, 2005
(86) PCT No.: PCT/BE05/00046

§ 371 Date: Oct. 2, 2006

(30) Foreign Application Priority Data
Apr. 2, 2004 (EP) 04008046.7

(51) Int. Cl. B03B 11/00

(52) U.S. Cl. 209/488

(57) ABSTRACT

A mechanical device for gravimetric concentration of minerals and known as a jig, operating according the known principle and general design thereof, being original in that a continuous and adjustable evacuation of the dense grained fraction occurs in closed compartments which, in this case, are the legs of the mechanical device.

### FIELD OF THE INVENTION

The invention relates to equipment for the gravimetric concentration of ores.

The invention relates more specifically to equipment for the artisanal concentration of ores, operating according to the known principle of jigging, which has a lightweight structure, can be easily moved over the ground and allows a high production capacity to be achieved, while ensuring the best recovery rate.

### PRIOR ART

Jigging is a well-known technique for the gravimetric concentration of solid materials comprising substances of different densities [for example, an ore stripped of its components (naturally for alluvial and eluvial deposits or after grinding), the cleansing of soil polluted with buckshot, or any other mixture of different materials].

By convention, in the rest of this specification, the term “ore” means a solid material in the state of particles of variable size and shape, consisting of two or more minerals of different densities. The term “slurry” means an aqueous dispersion or suspension of the ore in water or another appropriate liquid.

In the jigging technique, a slurry is subjected to a succession of cycles of alternately upward and downward pulses in a tank. A substantially horizontal grille divides the tank into two superimposed compartments and the slurry to be processed is introduced into the upper compartment. The totality of the particles of the slurry in the upper compartment of the tank is called “filter bed”. This bed may consist of the various components of the ore processed or, as a variant, of an additional material, of intermediate density. During the pulse cycles, the slurry particles are subjected to brief accelerations which produce an alternating cycle of slurry expansion and particle settling. A continuous water upflow is commonly superimposed on the upward and downward pulses, with the function of adjusting the suction during the downward pulses. Due to the combined effect of the upward and downward pulses, a densimetric (or gravimetric) stratification of the ore particles takes place in the tank, according to their density: a dense fraction settles in the tank and a light fraction is removed with the slurry by overflow from the tank. The dense fraction is divided into two subfractions, according to the grain size distribution: the fine grains pass through the grille and collect in the bottom of the tank, while the coarser particles are retained by the grille and collect above it.

The equipment used for implementing the jigging technique is sometimes called a “jig”.

There is a high demand at the present time for jigs of lightweight design, suitable for artisanal production close to immediately processable ore deposits.

This type of artisanal equipment is particularly popular with gold washers, who are particularly attracted by the ease of movement of this equipment and its ease of operation. Demand for this type of lightweight artisanal equipment is also expressed by prospectors of very low-assay deposits, in which it is necessary to analyze large quantities of ore to obtain representative results (this is the case in prospecting for diamonds, the useful content of which is concentrated in a few stones).

In the document “Pan African Jig—Concentrateur de minerais [ore concentrator]” by Sicotim, accessible on the Internet site http://www.sicinter.com, a jig meeting the requirements stated above is described. This known artisanal equipment comprises a tank that a substantially horizontal grille divides into two superimposed compartments. The equipment further comprises a device for feeding the tank with an ore slurry and a device for generating the water pulse cycles discussed above. This device consists of a piston or a membrane, located under the grille and operated by adequate means. This known artisanal equipment has the advantage of limited size; it can be easily moved, requires very little energy for its operation, and is compatible with what can be provided by a man over a complete working day.

In this known artisanal equipment, the means used for separating the dense and coarse-grained subfraction, collected above the grille, consists in collecting it in a siphon installed inside the tank, along the wall thereof. A door that can be opened from the outside is used to clear an opening made in the tank wall, opposite the siphon, and thereby to remove the dense and coarse-grained subfraction (or part thereof). This extraction means is essentially a batch means, constituting a major drawback. In fact, it is not possible to predict in advance the densimetric cut of the fraction taken and, a fortiori, not possible to obtain predefined or adjustable densimetric cuts. Furthermore, this batch extraction means does not permit steady-state operation during which the properties of the filter bed remain constant. Moreover, upon each opening of the door, a stream of slurry suddenly leaves the tank, and this disturbs the stratification of the slurry in the tank. These periodic disturbances of the slurry stratification in the tank constitute a major drawback of this known equipment, being particularly detrimental to its effectiveness, its productivity and its energy efficiency. This known equipment requires expert, skilled and, consequently, costly personnel, thereby increasing the operating cost.

The known artisanal equipment thus described is not adaptable. In other words, its productivity is imposed by its dimensions and cannot be increased, thereby constituting a further drawback of this equipment.

An additional drawback of this known equipment lies in its size, which cannot be reduced for transport.

### SUMMARY OF THE INVENTION

The aim of the invention is to remedy the drawbacks of the known jig, described above, by providing a jig of novel design, which is specially adapted to artisanal production.

It is one object of the invention to provide a jig for artisanal production, in which the extraction of a dense fraction of ore does not cause a disturbance in the stratification of the slurry in the settling tank.

It is a further object of the invention to provide a jig for artisanal production, which allows, at will, the densimetric cut of the dense fraction drawn off from the upper compartment of the tank to be adjusted.

It is a further object of the invention to provide a jig for artisanal production, the operation of which is compatible with inexpensive manpower.

It is an additional object of the invention to provide a jig for artisanal production, the operation of which only requires a moderate input of energy, while having high productivity.

It is a further object of the invention to provide a jig for artisanal production, the productivity of which can be optimized in each particular case, according to the ore processed, its origin, and the desired degree of concentration.

It is a further object of the invention to provide a substantially multipurpose jig, which can be adapted easily to the ore processed so that its effectiveness is optimal in each particular case, even for low-grade ores, or those in which the density of the useful material is not very different than that of the other ore components.

It is a further object of the invention to provide a jig having all the above properties, of which the weight and size are reduced, and which can accordingly be conveyed easily to a production site.

In consequence, the invention relates to artisanal equipment for concentrating ores, comprising:
a tank divided into an upper compartment and a lower compartment by a grille;
a device for feeding the upper compartment of the tank with an ore slurry;
a device for producing upward water pulses through the grille;
a device for extracting a dense and fine-grained fraction of the ore from the lower compartment of the tank;
a device for extracting a dense and coarse-grained fraction of the ore from the upper compartment of the tank, this device comprising at least one siphon which is located in the tank and which communicates with at least one opening made in a side wall of the tank, above the grille; and
an overflow for removing a light fraction of the slurry from the upper compartment of the tank, the equipment being characterized in that said opening in the tank wall discharges into a chamber, the upper end of which is located at a higher level than said overflow.

The artisanal equipment of the invention belongs to the category of equipment known by the term “jig” and designed for concentrating ores, coal and other solid inorganic or organic materials by jigging. This technique is well known and its functional characteristics were discussed above.

The equipment according to the invention is artisanal equipment. The expression “artisanal equipment” means equipment of lightweight and inexpensive design, for which the investment, acquisition, maintenance and operating costs are within the scope of an skilled worker (according to the definition generally given in French language dictionaries, particularly in Le Petit Robert—dictionary of the French language, Editions Dictionnaires Le Robert, Paris, June 2000, page 147), as opposed to industrial equipment that involves considerable investment and a large, highly trained and costly manpower, generally beyond the scope of an individual of average affluence.

In the artisanal equipment according to the invention, the tank is the receptacle in which the jigging is performed. The shape of the tank is not critical. It may generally be prismatic, or have a rectangular or square cross section. The tank is divided by a grille into two superimposed compartments. The grille may be horizontal or oblique. The meshes of the grille are generally of uniform shape and size. They are preferably square, although other shapes are compatible with the invention.

In the present specification, the expression “fine-grained fraction of the ore” means a grain-size fraction whose particles have dimensions enabling them to pass through the grille. The coarse-grained fraction is a grain-size fraction whose the particles have dimensions larger than the meshes of the grille and are consequently stopped by it. The grille is sized according to the grain size distribution desired for the dense and fine-grained fraction of the processed ore. The optimum size of the grille accordingly depends on various parameters, particularly on the ore processed, and may be easily determined by a person skilled in the art. The lower compartment of the tank or a part thereof advantageously has the shape of a hopper. The tank and the grille must be made from a material capable of mechanically and chemically withstanding the slurries intended to circulate therein and the turbulence and abrasion forces generated by the pulsing of the water through the grille.

The device used to feed the tank with the ore slurry is not critical for the implementation of the invention. In one advantageous embodiment of the invention, the feed device comprises a channel in which the ore is mixed with water to obtain the necessary dilution. The channel is advantageously lined with a wear layer of a material capable of withstanding the abrasive action of the ore poured thereinto. It may be integral with the tank or, as a variant, it may be removably attached thereto. It is preferably removable in order to decrease the size of the artisanal equipment during transport. The use of a removable inlet channel serves to adjust their shape, dimensions and abrasion resistance, according to the ores processed. The use of a removable inlet channel also allows it to be substituted with a different feed, for example, a chute or a screw conveyor.

The water-pulsing device is an essential component for jigging. It is designed to project a stream of water upward through the grille of the tank at regular intervals, so that the slurry in the upper compartment of the tank is subjected to a succession of cycles of alternately upward and downward pulses, as mentioned above. However, the method of producing this device is not critical for the definition of the invention. It may, for example, comprise a piston traveling in an auxiliary chamber and communicating with the lower compartment of the tank, or a flexible membrane placed under the grille, the central zone of the membrane being subjected to a controlled reciprocating movement.

The lower compartment of the tank comprises a device for extracting a dense and fine-grained fraction of the ore. This device is not critical for the design of the invention and may, for example, comprise a hopper blocked by a flap.

The upper compartment of the tank communicates with an overflow that is located at a higher level than the grille. The overflow has the function of keeping the slurry levels in the tank substantially constant during normal operation of the artisanal equipment. In a manner known per se, the fraction of the slurry that leaves the tank via the overflow normally contains a light fraction of the slurry.

The device for extracting a dense and coarse-grained fraction of ore from the tank is an important constructive component of the artisanal equipment of the invention. According to the invention, this extraction device comprises
on the one hand, a siphon that communicates with the upper part of the tank, this siphon discharging into an opening made through the tank wall, above the grille; and
on the other, a chamber which is located outside the tank, so that its upper end is at a higher level than that of the grille.

The siphon is advantageously inside the tank and may then be formed by a vertical or oblique partition, immersed in the slurry, above the grille, facing the abovementioned opening. The lower edge of said partition is accordingly located above the grille, but at a level lower than that of the overflow, and the lower edge of the opening is located at an intermediate level between that of the overflow and that of the lower edge of the partition. Any other equivalent device can serve as a siphon.

Said opening in the tank wall is partitioned so that the slurry from the siphon can flow into the chamber. During normal operation of the artisanal equipment, the pouring of the slurry from the siphon into the chamber does not affect the slurry level in the tank, because the upper end of the chamber is located at a higher level than the tank overflow.

In one particular embodiment of the artisanal equipment of the invention, the siphon comprises, as stated above, a vertical partition which, during normal operation of the artisanal equipment, is immersed in the slurry above the grille, facing the opening made in the tank wall. In a preferred version of this embodiment, the partition is a vertically movable shutter facing said opening. This version of the invention serves to adjust the density of the cut of the coarse-grained fraction of the ore, drawn off via the overflow.

During normal operation of the artisanal equipment of the invention, the dense and coarse-grained fraction of the ore processed progressively accumulates in the chamber. This must accordingly be periodically drained of the ore it contains. In an advantageous embodiment of the artisanal equipment of the invention, an openwork basket is suspended in the chamber. The basket has the function of collecting the ore particles that fall into the chamber. It therefore suffices to raise the basket periodically in order to extract it from the chamber and gather the ore that it contains, without adversely affecting the operation of the artisanal equipment.

The artisanal equipment of the invention is a jig intended for artisanal production. It can be designed so that it is easily handled by a single person and can be transported in light vehicles, on any type of road, and can be easily loaded onto aircraft of the small carrier type. For this purpose, in a preferred embodiment, the tank and its grille, the feed device, the overflow, the water-pulsing device and the siphon chamber form a coherent whole which is mounted on legs. The number of legs is normally at least three in order to make the assembly isostatic. In practice, at least four legs are generally used.

In one advantageous version of the preferred embodiment described above, the abovementioned siphon chamber is provided in at least one of the legs of the artisanal equipment. It is preferable for said chamber and said siphon to be provided in each leg. This embodiment of the artisanal equipment has the advantage of reducing its size and weight and facilitating its assembly.

In another embodiment, which is preferred, the artisanal equipment of the invention comprises four legs and the device for extracting the dense and coarse-grained fraction of the ore from the upper compartment of the tank comprises:
on the one hand, four chambers like the one defined above, each provided in a different leg of the artisanal equipment; and
on the other, four siphons which communicate, each with a different opening made in the tank wall, these four openings each terminating in one of said four chambers.

The components of the artisanal equipment of the invention are preferably made from lightweight materials, which can withstand stresses on site. For this purpose, in one particular embodiment, the structure is made from epoxy/fiberglass laminate by the vacuum impregnation technique offering an excellent weight/mechanical strength ratio.

In an additional embodiment of the artisanal equipment of the invention, this is formed from removable components allowing the rapid assembly and disassembly of said equipment. This embodiment of the invention is particularly well suited to lightweight and easily handled artisanal equipment, the tank then being able to serve as a receptacle for housing therein the other components of the equipment, so as to minimize the volume to be handled.

In one particular embodiment of the invention, the artisanal equipment comprises a second tank, placed downstream of the overflow. In this embodiment, the second tank is similar to the tank described above and, like said tank, also comprises a grille which divides it into an upper compartment and a lower compartment. This second tank is also connected to a water-pulsing device, which is designed in a manner known per se to project a stream of water upward through the grille of the tank at regular intervals, so that the slurry in the upper compartment of the tank is subjected to a succession of cycles of alternately upward and downward pulses, as discussed above. This second tank is also equipped with at least one siphon terminating in at least one chamber located outside the tank, as stated above. This embodiment of the invention serves to improve the ore production yield.

In a preferred execution of the artisanal equipment of the invention, the water-pulsing device comprises:
on the one hand, a flexible and sealed membrane dividing the lower compartment of the tank into two contiguous subchambers; and
on the other, a membrane-activating member, designed to subject a central zone thereof to a to-and-fro reciprocating movement.

In this preferred execution of the artisanal equipment of the invention, the flexible membrane may be vertical or oblique. It is preferable to use a vertical membrane. The membrane is also advantageously positioned so that the two subchambers have substantially equal volumes.

For the implementation of the preferred execution described above, the membrane may, for example, be mounted on a peripheral frame which is introduced into the lower compartment of the tank to form the partition between the two abovementioned subchambers. In an especially advantageous embodiment, a removable wall is fixed to the upper part of the frame, above the grille, to allow adjustment of the discharge height from the first compartment into the second. In this advantageous embodiment, the upper edge of said removable wall must be located below the overflow level.

In the preferred execution defined above, the membrane may be activated by any adequate and known member. A known member is advantageously used, associating a connecting rod-crank system. A member associating a connecting rod-crank system has the advantage of being manually operable using a pedal assembly. This embodiment of the invention thus has the advantageous feature of being operable by an animal or a human being, without requiring any other drive power.

In an advantageous version of the preferred embodiment described above, the two subchambers of the lower compartment of the tank are prolonged respectively by two hoppers and the membrane-activating member is located between the two hoppers. This embodiment of the invention minimizes the size thereof. It has the additional advantage of allowing the juxtaposition of a second tank against the sill of the overflow, this second tank being similar to the first tank and comprising a second membrane and an activation device thereof. By thus placing two or more tanks in series one after the other, each equipped with a membrane and a self-contained membrane-activating device, the effectiveness of the artisanal equipment of the invention can be adjusted at will and easily. The artisanal equipment according to this embodiment of the invention is accordingly a jig consisting of independent modules of two or more juxtaposed tanks having their own drive mechanism, which can be assembled in series in order to increase the depletion of ores that are particularly difficult to concentrate. This placing of several modules in series serves to maximize the productivity by controlling the recovery in each caisson, which observes an asymptotic distribution.

The artisanal equipment of the invention has the advantage of being compact and having a high productivity. In general, for equivalent size, the productivity of the artisanal equipment of the invention is at least 30 times greater than that obtained by conventional artisanal methods and allows for higher recovery rates.

The artisanal equipment of the invention has many applications. It has one particular application for concentrating soil or ores occurring naturally in the granular or powder state, as for example, alluvial products. The artisanal equipment of the invention is especially appropriate for deposits of this type located in geographic areas of difficult access, for example, geographic areas remote from communication channels, as many exist on the African continent, particularly in the Democratic Republic of Congo. The artisanal equipment of the invention has a very particular application for the artisanal concentration of ores, gold, diamonds, or any valuable mineral, of different density to the environment (cassiterite, wolframite, coltan, tourmaline, garnet, chrysoberyl, spinel, zircon, tanzanite, rhodonite, ruby, sapphire, etc.).

### BRIEF DESCRIPTION OF THE FIGURES

The figures presented represent one embodiment of the invention.

FIG. 1 shows a vertical and longitudinal cross section of a schematic embodiment of the artisanal equipment of the invention.

FIG. 2 shows a cross section along the plane II-II of FIG. 1.

FIG. 3 is a planar view of a preferred embodiment of the equipment according to the invention.

FIG. 4 is a vertical cross section along the plane IV-IV in FIG. 3.

FIG. 5 is a perspective view of the artisanal equipment in FIGS. 3 and 4.

FIG. 6 is a large-scale view of a detail of the equipment in FIGS. 3 to 5.

FIG. 7 shows the equipment in FIGS. 3 to 6, in a vertical and longitudinal cross section.

FIG. 8 is a large-scale view of a detail in FIG. 5.

In these figures, the same reference numeral denotes the same element.

### DETAILED DESCRIPTION OF PARTICULAR EMBODIMENTS

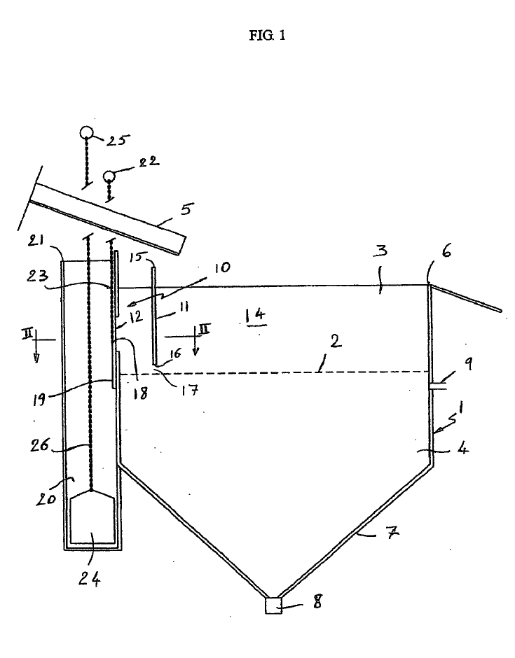

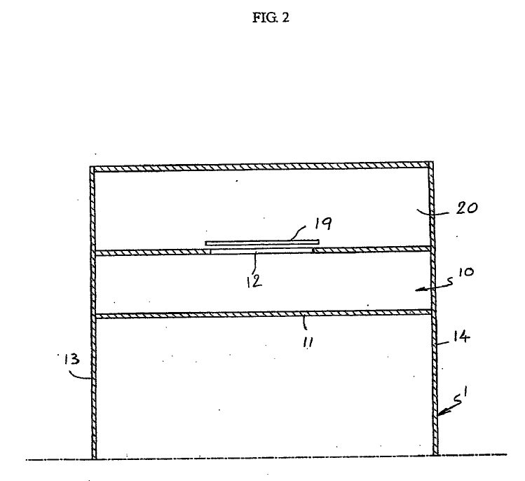

The equipment shown in FIGS. 1 and 2 comprises a tank (1) equipped with a substantially horizontal grille (2).

The grille (2) divides the tank into two compartments: an upper compartment (3) and a lower compartment (4).

An inclined channel (5) discharges into the upper compartment (3). It serves as an inlet for an ore slurry to be classified.

The upper compartment (3) communicates with the overflow (6), which is located at a lower level to that of the upstream end of the channel (5).

The lower compartment (4) is prolonged downward by a hopper or hutch (7) blocked by an appropriate valve (8).

During the operation of the equipment in FIG. 1, the channel (5) is fed with ore of specified grain size distribution, at an adequate flow rate. The latter must be determined by a series of prior tests, because it depends on the ore processed. A water feed (not shown) dilutes this ore in order to obtain a feed-slurry dilution of about 1/1 (by weight).

The slurry water fills the entire tank (1), up to the overflow (6) level. The ore particles penetrate into the slurry.

A suitable pulsing device, not shown in FIG. 1, but well known in the jigging technique, subjects the water of the lower compartment (4) to upward pulses, which expel it through the grille (2), into the upper compartment (3). These pulses generate a cycle of alternating fluidizations and settlings of the slurry, which has the result of stratifying the solid particles of the slurry in the upper compartment (3): the densest particles penetrate into the filter bed and reach the grille (2). The dense grains smaller in size than the grille mesh pass through it and fall into the hutch (7) where the valve (8) serves to extract them.

The dense grains, rejected by the grille (2), accumulate thereon and the slurry is thereby stratified into layers of increasing density.

The light fraction of the slurry, of which the grains do not reach the grille (2), is removed from the tank (1) via the overflow (6).

During said water pulses, it is recommended to control the suction effect during the settling phases by means of an auxiliary water feed (9) under the grille (2).

The dense grains which accumulate on the grille (2) must be removed therefrom. According to the invention, this removal is performed in a continuous and controlled manner, offering the great advantage of guaranteeing steady operation of the equipment. For this purpose, the upper compartment (3) comprises a siphon (10), which comprises, on the one hand, a vertical partition (11) immersed in the slurry and, on the other, an opening (12) made through the tank (1) wall. The partition (11) joins the opposite walls (13) and (14) of the tank (1). Its upper edge (15) is located at a level higher than that of the overflow (6) and its lower edge (16) is located above the grille (2), arranging a passage (17) for the grains of ore accumulated on the grille (2).

The sill of the opening (12) is formed by the upper edge (18) of a panel (19) which can slide vertically and in a sealed manner along the wall of the tank (1). Said edge (18) is normally located at an intermediate level between those of the sill (6) and of the lower edge (16) of the partition (11).

The opening (12) discharges into a chamber (20) located outside the tank (1). The chamber (20) has its upper end (21) located at a higher level than that of the overflow (6) in order to prevent it from overflowing.

Due to the pressure generated by the thickness of the slurry in the upper compartment (3), the dense stratified grains on the grille (2) are expelled through the passage (17) under the partition (11) and penetrate into the siphon (10). In the siphon (10), the grains are fluidized in the same way as those of the compartment (3). Their level rises progressively to reach the equilibrium level which depends on the density differential between the slurries in the compartment (3) and in the siphon (10). The panel (19) is positioned under this slurry equilibrium level, for continuous removal of the grains which penetrate into the siphon (10). The height positioning of the panel (19) defines the extraction rate from the siphon and thereby determines the densimetric cut.

The panel (19) is positioned by means of a winch (22) (or equivalent device), from which the panel (19) is suspended via a chain (23).

A basket (24) placed in the bottom of the chamber (20) serves to collect the grains of ore that penetrate into said chamber (20) via the opening (12). The basket (24) is connected to a winch (25) via a chain (26), for periodic extraction from the chamber (20) and thereby, recovery of the grains of ore accumulated therein. The walls of the basket (24) are perforated to permit the flow of water during its extraction from the chamber (20). Before extracting the basket (24) from the chamber (20), it is advisable to raise the panel (19) to momentarily stop the passage of the grains of ore from the siphon (10) into the chamber (20).

In one particular embodiment of the artisanal equipment in FIGS. 1 and 2, the grille (2) represents the bottom wall of a shallow basin, of which the side wall is applied against the wall of the tank 1. This embodiment of the artisanal equipment permits easy replacement of the basin. It also permits the use of the basin only, for example, to filter an ore broth or slurry.

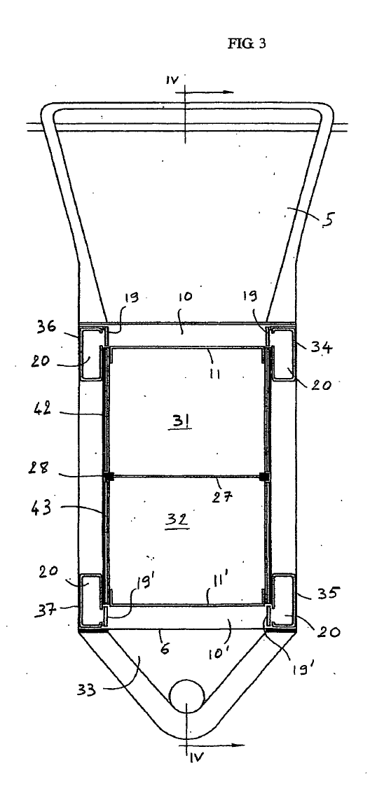

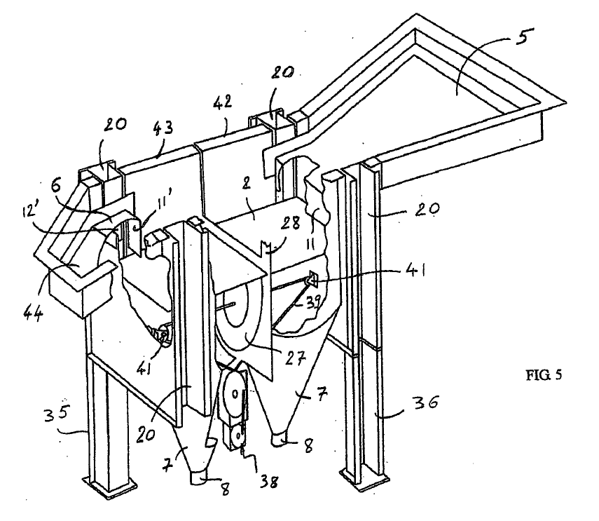

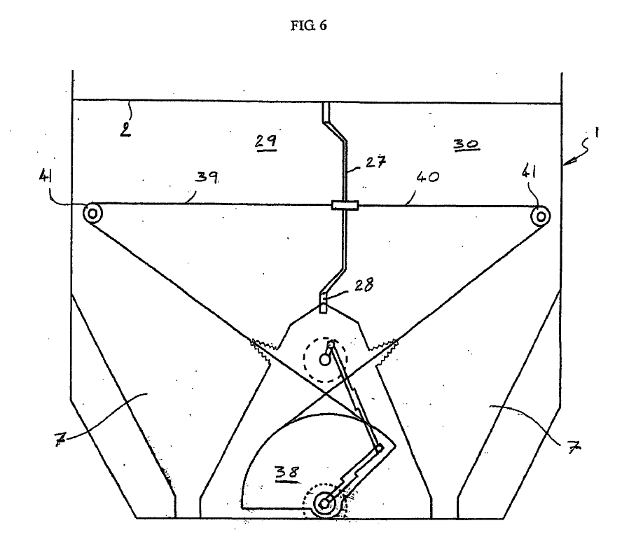

In the preferred embodiment of the invention, shown in FIGS. 3 to 8, the tank (1) is rectangular. It is mounted on four legs (34), (35), (36) and (37), which are placed respectively at the four corners of the tank (1). The pulsing device comprises a vertical membrane (27) in the lower compartment (4) of the tank (1). The function and operation of the membrane (27) will be explained below. The membrane (27) is mounted in a frame (28), in order to divide the compartment (4) into two juxtaposed subchambers (29) and (30). The frame (28) is prolonged above the grille (2) in order to divide the upper compartment (3) into two juxtaposed subchambers (31) and (32). The upper edge (33) of the frame (28) is located at a lower level than that of the overflow (6).

The two subchambers (29) and (30) are each prolonged by a hopper or hutch (7), equipped with a valve (8). The two hutches (7) meet along the lower edge of the frame (28).

The channel (5) is a module that is clipped to the tank (1), so that its bottom wall is prolonged by the vertical partition (11) that is vertically immersed in the subchamber (31) of the tank (1).

The overflow (6) is prolonged by an inclined channel (44) which is clipped to the tank (1). The bottom wall of the channel (44) is prolonged by a vertical partition (11′). The partition (11′) is similar to the abovementioned partition (11) and forms a siphon (10′) in the vicinity of the downstream end of the tank (1).

For the transport of the artisanal equipment in FIGS. 3 to 8, the modules (5) and (44) are detached from the tank (1) and placed therein, in order to minimize the outside volume.

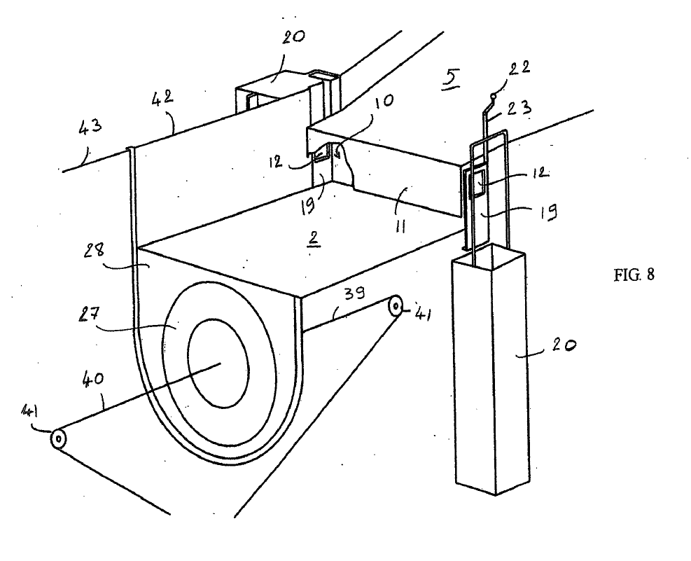

The artisanal equipment in FIGS. 3 to 8 comprises four chambers (20), which are located respectively inside the four legs (34), (35), (36) and (37). The siphon (10) accordingly comprises two vertical panels (19) vertically movable in front of the corresponding openings (12) of the chambers (20) of the legs (34) and (36) (FIGS. 3 and 8). Similarly, the siphon (10′) comprises two vertical panels (19′) which are vertically movable in front of the corresponding openings (12′) of the chambers (20) of the legs (35) and (37) (FIG. 3).

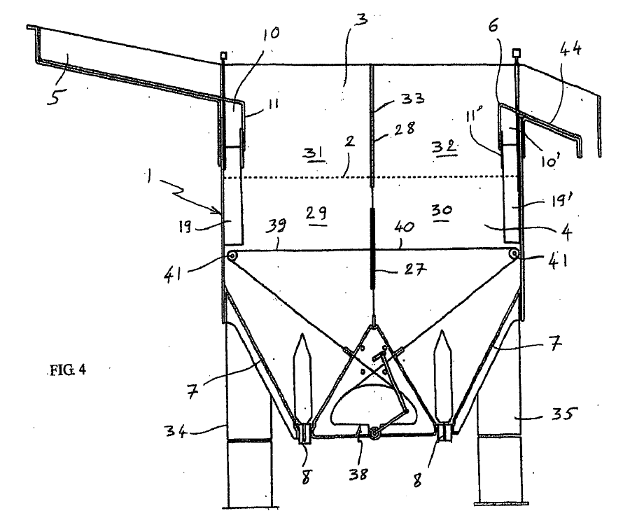

In FIGS. 3 to 8, the membrane (27) has a circular shape. However, any other appropriate shape is suitable. The membrane (27) constitutes the pulsing device of the equipment. For this purpose, a connecting rod-crank system (38) (FIGS. 4, 5 and 6) located in the free space between the two hutches (7) is connected to a pair of cables (39) and (40). The two cables (39) and (40) pass respectively on two return pulleys (41) and are fixed respectively to the two sides of the membrane (27). The activation of the connecting rod-crank system (38) causes a to-and-fro movement of the membrane (27) which generates pulses in the two lower subchambers (29) and (30) of the tank (1).

In the equipment shown in FIGS. 3 to 8, the tank (1) is formed by the juxtaposition of two caissons (42) and (43), between which the frame (28) of the membrane (27) is inserted (FIG. 3).

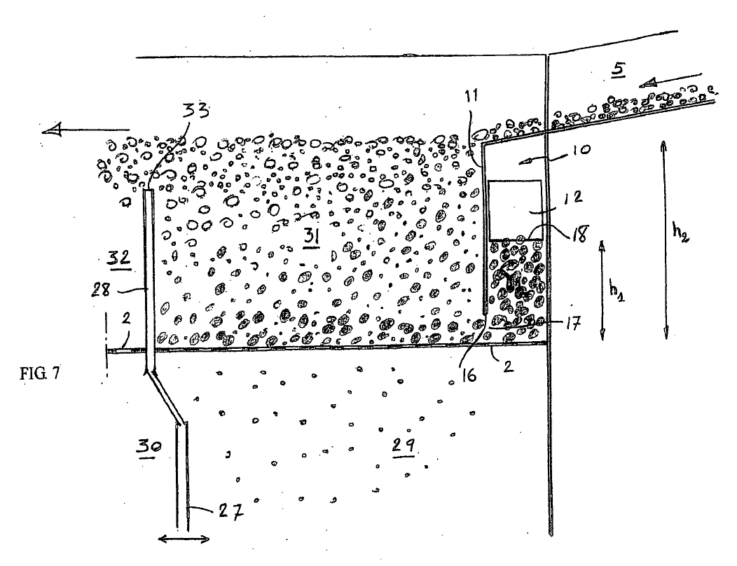

During the operation of the artisanal equipment in FIGS. 3 to 8, the ore to be processed is poured into the inlet channel (5), with water, to form a slurry. The slurry enters the subchamber (31) of the tank (1), which is located above the grille (2). The connecting rod-crank system (38) is activated permanently to distort the membrane (27) and generate the pulses in the tank. The ore is progressively stratified in the subchamber (31), as stated above for the equipment in FIG. 1. The dense fraction of the ore settles in the subchamber (31) reaching the grille (2). The fine particles of the dense fraction pass through the grille (2), entering the lower subchamber (29) and are collected in the hutch (7) of the subchamber (29). The coarse-grained particles of said dense fraction are retained on the grille (2), where they progressively accumulate. As in the case of the equipment in FIG. 1, these coarse-grained particles flow progressively into the siphon (10) and, from there, into the two chambers (20) of the two legs (34) and (36), where they fall into the baskets (24). A less dense fraction of the slurry passes above the frame (28) up to the chamber (32). FIG. 7 shows the distribution of the dense fraction of the ore in the subchamber (31), above the grille (2). The mean density of the part of this fraction which passes into the siphon (10) is higher than that of the part remaining in the subchamber (31), so that an equilibrium is established defined by the mathematical equation:

H₁·d₁=h₂·d₂,

in which:

d₁ denotes the mean density of the ore in the chamber (31), outside the siphon (10);

d₂ denotes the mean density of the ore in the siphon (10);

h₁ denotes the height of the overflow (6) above the grille (2); and

h₂ denotes the height of the sill (18) of the opening (12).

In the chamber (32), the slurry is also subjected to the pulses generated by the membrane (27). The dense particles that have not settled in the subchamber (31) settle in the subchamber (32). The dense fine-grained particles pass through the grille (2) and are collected in the hutch (7) which is located below the subchamber (30). The coarse-grained particles which are retained by the grille (2) accumulate thereon and pass progressively into the siphon (10′) and, from there, into the chambers (20) of the legs (35) and (37), where they fall into the baskets (24). The fine-grained fraction of the slurry passes above the sill of the overflow (6) and is removed via the outlet channel (44).

As described above, in the equipment in FIGS. 3 to 8, the tank (1) is formed by the juxtaposition of two caissons (42) and (43), between which the frame (28) of the membrane (27) is inserted. The two caissons (42) and (43) are assembled along juxtaposed flanges (not shown), which are cemented or bolted. The two caissons (42) and (43) may be of metal or of a synthetic resin. For a question of weight, it is preferable to make them of synthetic resin. This design of the artisanal equipment of the invention permits a construction of composites by the vacuum impregnation method and serves to incorporate the support of the drive mechanism (38) of the membrane (27) in these two caissons.

1. Artisanal equipment for concentrating ores, comprising:
a tank (1) divided into an upper compartment (3) and a lower compartment (4) by a grille (2);
a device (5) for feeding the upper compartment of the tank with an ore slurry;
a device (27, 38, 39, 40, 41) for producing upward water pulses through the grille;
a device (8) for extracting a dense and fine-grained fraction of the ore from the lower compartment of the tank;
a device for extracting a dense and coarse-grained fraction of the ore from the upper compartment of the tank, this device comprising at least one siphon (10) which is located in the tank and which communicates with at least one opening (12) made in a side wall of the tank, above the grille; and
an overflow (6) for removing a light fraction of the slurry from the upper compartment of the tank, characterized in that said opening (12) in the tank wall discharges into a chamber (20), the upper end of which (21) is located at a higher level than said overflow.

2. The artisanal equipment as claimed in claim 1, characterized in that the lower edge (18) of said opening (12) can be moved vertically.

3. The artisanal equipment as claimed in either of claims 1 and 2, characterized in that the tank (1), the feed device (5), the overflow (6) and the siphon (10) form a coherent whole, mounted on legs (34, 35, 36, 37) and in that the chamber (20) is provided inside one of said legs.

4. The artisanal equipment as claimed in any one of claims 1 to 3, characterized in that the siphon (10) comprises a substantially vertical partition (11) and in that the feed device (5) comprises an inclined channel, the bottom wall of which is connected to said partition of the siphon.

5. The artisanal equipment as claimed in claim 4, characterized in that the channel (5) and the partition (11) form a removable coherent whole.

6. The artisanal equipment as claimed in any one of claims 1 to 5, characterized in that the water-pulsing device comprises, on the one hand, a flexible and sealed membrane (27) dividing the lower compartment (4) of the tank (1) into two contiguous subchambers (29, 30) and, on the other, a membrane-activating member (38, 39, 40, 41) designed to subject a central zone of the membrane to a to-and-fro alternating movement.

7. The artisanal equipment as claimed in claim 6, characterized in that the tank is formed from two contiguous caissons (42, 43), between which the membrane is inserted.

8. The artisanal equipment as claimed in either of claims 7 and 8, characterized in that the two subchambers (29, 30) of the lower compartment (4) of the tank are prolonged respectively by two hoppers (7) and in that at least part of the membrane-activating member (38) is located between the two hoppers.

9. The artisanal equipment as claimed in any one of claims 1 to 8, characterized in that the grille (2) constitutes at least part of the bottom wall of a basin which is placed removably in the tank.

10. The artisanal equipment as claimed in any one of claims 1 to 9, characterized in that it comprises a plurality of tanks (1) mounted in series one behind the other, so that the overflow (44) of an upstream tank is the feed device (5) of the tank located immediately downstream of the upstream tank.
